(19) United States
(12) Patent Application Publication
(10) Pub. No.: US 2025/0170017 A1
(43) Pub. Date: May 29, 2025

(54) MASSAGE DEVICE HAVING MASSAGE MODULE

(71) Applicant: CERAGEM CO., LTD., Cheonan-si, Chungcheongnam-do (KR)

(72) Inventors: Dong Myoung LEE, Asan-si, Chungcheongnam-do (KR); Sang Ho CHOI, Cheonan-si, Chuncheongnam-do (KR); Seung Jong LEE, Cheongju-si, Chungcheongbuk-do (KR); Su Hyun KIM, Cheonan-si, Chuncheongnam-do (KR); Hyung Joo LEE, Cheonan-si, Chuncheongnam-do (KR)

(21) Appl. No.: 18/868,711

(22) PCT Filed: May 22, 2023
(86) PCT No.: PCT/KR2023/006928

§ 371 Date: Nov. 22, 2024

(30) Foreign Application Priority Data
May 24, 2022 (KR) 10-2022-0063276

(51) Int. Cl. A61H 39/04; A61H 15/00

(52) U.S. Cl. CPC A61H 39/04; A61H 15/0078; A61H 2201/0107; A61H 2201/1623; A61H 2201/1666; A61H 2201/1669; A61H 2205/081

(57) ABSTRACT

The present invention relates to a massage device. More specifically, disclosed is a massage device having a massage module for massaging, through pressing, the body of a user lying thereon. The massage device having a massage module, according to one aspect of the present invention, comprises: a pad having a support surface for supporting the body of the user, and an opposite surface disposed to be opposite to the support surface; and a massage module insertively disposed in the pad and having acupressure members that press the body of the user while moving in the longitudinal direction, wherein the acupressure members include acupressure tools each arranged at one side and the other side thereof in the width direction with respect to the center thereof in the width direction, the support surface has hollow portions in which the acupressure tools can move, so that the acupressure tools are raised to a position higher than that of the support surface in the height direction while the massage module is moving, and the pad can have an additional support surface disposed between the acupressure tools arranged to be opposite to each other, so that the body of the user is supported.

### TECHNICAL FIELD

The present invention relates to a massage device, and more particularly to, a massage device having a massage module for massaging, through pressing, the body of a user lying thereon.

### BACKGROUND

Conventionally, a massage device has been widely used that moves along the body part and improves blood circulation through stimulation by the heat to painful area in order to alleviate acute or chronic pain that occurs in the muscles and nervous tissue of the spine region caused by continuing work in an inappropriate posture for a long time or becoming a habit of this posture for a long time, to improve blood circulation in the body or to relieve momentary muscle stiffness or the like.

Such a conventional massage device is equipped with an acupressure tool that presses the user's body inside a pad supporting the user's body. Such acupressure tools are disposed on both sides of the user's spine in the width direction. That is, while the user is lying on the upper surface of the pad, the acupressure tools move along the longitudinal direction of the pad and rise or descend according to the shape of the user's spine to provide more accurate and sophisticated therapeutic effects to the user's spine.

The aforementioned pad has an opening so that the acupressure tools placed on both sides of the user's spine in the width direction rise higher than the upper surface of the pad or descend lower than the upper surface of the pad while moving in the longitudinal direction, and as the hollow portions with the width through which the acupressure tools placed on both sides of the width direction can pass extend along the longitudinal direction of the pad, the user's body part falls into this opening, making it difficult for the user to lie on the top of the pad or raise the upper body after massage.

Therefore, there is a need for improvement in this area.

### DISCLOSURE

### Technical Problem

The present invention is to solve the above problems, and the present invention is directed to providing a massage device having a massage module that can minimize the user's body from falling into a hollow portion even in the state in which the hollow portion is formed so that acupressure tools arranged on both sides of the width direction rise to a higher position or descend to a lower position than the support surface of the pad.

The problems of the present invention are not limited to those mentioned above, and other problems not mentioned will be clearly understood by those of ordinary skill in the art from the following description.

### Technical Solution

According to one aspect of the present invention, provided is a massage device having a massage module, the massage device including a pad having a support surface for supporting a body of a user, and an opposite surface disposed to be opposite to the support surface; and a massage module insertively disposed in the pad and having acupressure members that press the body of the user while moving in the longitudinal direction, wherein the acupressure members include acupressure tools each arranged at one side and the other side of the acupressure member in the width direction with respect to the center of the acupressure member in the width direction, wherein the support surface has hollow portions through which the acupressure tools are able to move so that the acupressure tools are raised to a higher position than that of the support surface in the height direction while the massage module is moving, and wherein the pad has an additional support surface disposed between the acupressure tools arranged to be opposite to each other to support the user's body.

In this case, the pad may include an additional frame having the additional support surface.

In this case, the massage module may include a transfer part that moves along the longitudinal direction, a support part wherein the acupressure member is disposed on one side of the support part and the other side of the support part is hinge-fixed to the transfer part, and a lifting/lowering part that raises or lowers one side of the support part.

In this case, the support part may include support members disposed on one side and the other side of the support part in the width direction, respectively, and the acupressure tool may be disposed on each said support member.

In this case, the hollow portion may be configured to have a width corresponding to a width of the support member so that the acupressure tool rises to a higher position or descends to a lower position than the support surface while the massage module moves along the longitudinal direction.

In this case, the hollow portion may be configured to have a width corresponding to a width of the acupressure tool so that the acupressure tool rises to a higher position or descends to a lower position than the support surface while the massage module moves along the longitudinal direction.

In this case, a lower surface of the additional frame may be disposed adjacent to an upper surface of the transfer part.

In this case, the lifting/lowering part may include a lifting/lowering member provided on each said support member, and a driving member that provides driving force for the lifting/lowering member to rise or descend along the height direction.

In this case, the support member may include a plurality of unit plates divided along the width direction, each said unit plate may have the acupressure tool, and the pad may have an additional support surface disposed between the unit plates to support the user's body.

In this case, the pad may further include a unit frame having the additional support surface.

In this case, the lifting/lowering part may include a lifting/lowering member provided on each said unit plate, and a driving member that provides driving force for the lifting/lowering member to rise or descend along the height direction.

### Advantageous Effect

According to the above configuration, in the massage device having a massage module according to an exemplary embodiment of the present invention, the additional support surface for supporting the user's body is provided between the acupressure tools arranged opposite to each other in the state in which the acupressure tools arranged on both sides of the width direction rise to a higher position or descend to a lower position than the support surface of the pad, thereby minimizing the user's body falling into the hollow portion, thereby improving user convenience by allowing the user to lie comfortably on the pad or easily raise the upper body after massage.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view of a massage device according to an exemplary embodiment of the present invention.

FIG. 2 is a cross-sectional view illustrating a state in which a massage module is inserted and disposed in a massage device according to an exemplary embodiment of the present invention.

FIG. 3 is a perspective view of a massage module according to an exemplary embodiment of the present invention.

FIG. 4 is a front view illustrating a massage module viewed from the bottom according to an exemplary embodiment of the present invention.

FIG. 5 is a perspective view of a massage device according to another exemplary embodiment of the present invention.

FIG. 6 is a cross-sectional view illustrating a state in which a massage module is inserted and disposed in a massage device according to another exemplary embodiment of the present invention.

FIG. 7 is a perspective view of a massage module according to another exemplary embodiment of the present invention.

FIG. 8 is a front view illustrating a massage module viewed from the bottom according to another exemplary embodiment of the present invention.

### MODES OF THE INVENTION

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

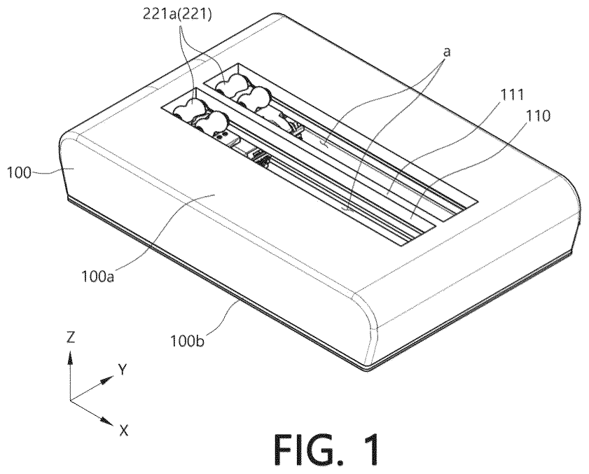

FIG. 1 is a perspective view of a massage device according to an exemplary embodiment of the present invention. Here, the X direction is the longitudinal direction of the pad, which means the direction in which the user lies, the Y direction means the width direction of the pad, and the Z direction means the height direction of the pad. For clarity of description of the present invention, parts not related to the description are omitted in the drawings.

As shown in FIG. 1, a massage device having a massage module according to an exemplary embodiment of the present invention includes a support surface 100a supporting the user's body, a pad 100b having an opposite surface 100b placed opposite the support surface 100a, and a massage module 200 having an acupressure member 221 that presses the user's body while moving along the longitudinal direction (X) while inserted into the pad 100.

The pad 100 may be provided in the main body part supporting the user's upper body, and the massage device may be provided with an auxiliary part connected to the main body part to support the user's lower body.

The support surface 100a formed on the pad 100 may be formed at the upper end of the pad 100 to support the user's upper body, and a separate lower body support surface for supporting the user's lower body may be formed in the auxiliary part. In this case, the support surface 100a may be configured to support not only the upper body of the user but also the hip, and the lower body support surface may be configured to support only the user's legs.

Alternatively, the pad 100 may be provided in an auxiliary part supporting the user's lower body, and the massage device may be provided with a main body part supporting the user's upper body, and the auxiliary part may be connected to this main body part. In this case, the support surface 100a may be formed at the upper end of the pad 100 to support the user's lower body, and a separate upper body support surface for supporting the user's upper body may be formed in the main body part.

Meanwhile, a separate leg member may be provided in the main body part equipped with the pad 100 so that the support surface 100a is spaced apart from the ground, allowing the user to receive massage in a comfortable position.

Such a leg member may be made in a substantially rectangular band shape. That is, it may include a side frame corresponding to a side surface of the main body part, a lower frame supported on the ground, and a connection frame connecting the side frame and the lower frame. The above-described frames may be made integrally, or may be combined after being made separately. Here, the side frame may be made in a plate shape, and the lower frame may be made in a rod shape.

A guide groove is formed in the above-described main body part, and a guide protrusion inserted into the guide groove is formed in the auxiliary part so that the auxiliary part can be configured to slide and move. Alternatively, it is also possible to form a guide groove in the auxiliary part and a guide protrusion in the main body part so that the auxiliary part can slide and move.

The acupressure member 221 provided in the massage module 200 is provided with a separate heating member to provide a thermal massage effect to the user. The acupressure member 221 may include acupressure tools 221a disposed on one side and the other side, respectively, in the width direction Y based on the center of the width direction Y. That is, when the user lies in the center of the pad 100 in the width direction Y, the acupressure tools 221a are configured to be disposed on both sides of the user's spine in the width direction Y, respectively. Accordingly, it is possible to provide a massage effect while pressing the acupuncture points (e.g., acupuncture points according to the bladder meridian) located on both sides along the user's spine.

For example, while the acupressure member 221 is disposed on one side and the other side in the width direction Y, respectively, the acupressure tool 221a may be disposed on each acupressure member 221, but is not necessarily limited thereto, and the acupressure tool 221a may be disposed on one side and the other side in the width direction Y of a single acupressure member 221.

In this case, the support surface 100a is provided with a hollow portion (a) through which the acupressure tool 221a is able to move so that the acupressure tool 221a rises along the height direction Z to a higher position than that of the support surface 100a while the massage module 200 is moving.

That is, while the acupressure tools 221a respectively placed on one side and the other side of the width direction Y moves along the length direction X, they press according to the shape of the user's spine while rising or descending along the height direction Z, but as the hollow portion (a) is formed, the acupressure tools 221a can directly press the user's body.

In this case, the pad 100 is provided with an additional support surface 111 disposed between the acupressure tools 221a disposed opposite to each other to support the user's body. In other words, as the additional support surface 111 is provided between the acupressure tools 221a respectively disposed on both sides of the width direction Y, when the user lies on the support surface 100a of the pad 100, this additional support surface 111 supports the user's spine to prevent the user's body from falling into the hollow portion (a).

In addition, the pad 100 may be equipped with a cloth cover member that can prevent foreign substances from entering the hollow portion (a) and prevent the user's body from falling into the hollow portion (a), but this cover member is not necessarily limited to the cloth material, and any material can be used as long as it can effectively transmit the pressing force of the acupressure tool 221a to the user's body.

In this way, the additional support surface 111 for supporting the user's body is provided between the acupressure tools 221a arranged opposite to each other in the state in which the acupressure tools 221a arranged on both sides of the width direction Y rise to a higher position or descend to a lower position than that of the support surface 100a of the pad 100, thereby minimizing the user's body falling into the hollow portion (a), thereby improving user convenience by allowing the user to lie comfortably on the pad 100 or easily raise the upper body after massage,

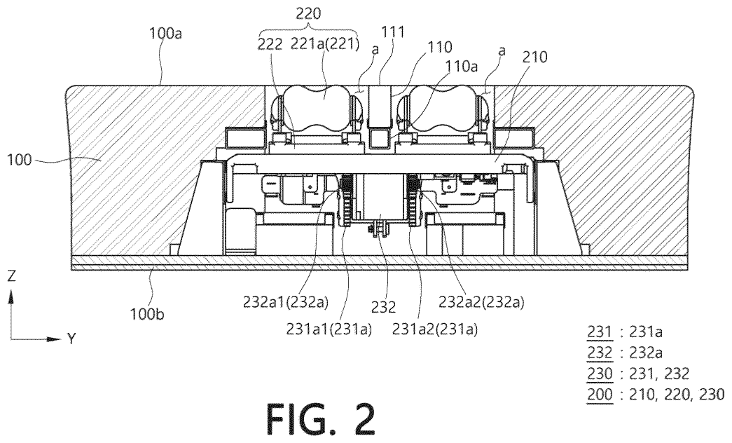

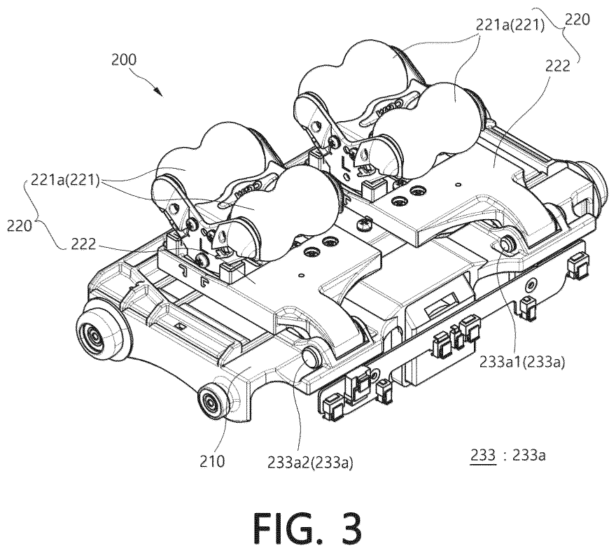

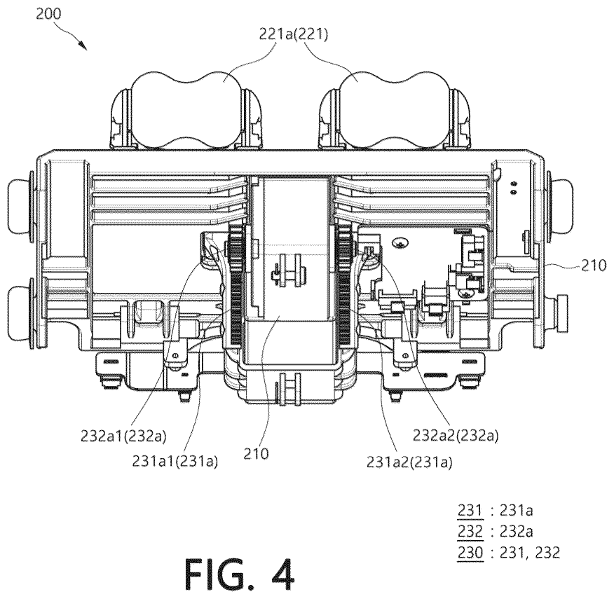

FIG. 2 is a cross-sectional view illustrating a state in which a massage module is inserted and disposed in a massage device according to an exemplary embodiment of the present invention, FIG. 3 is a perspective view of a massage module according to an exemplary embodiment of the present invention, and FIG. 4 is a front view illustrating a massage module viewed from the bottom according to an exemplary embodiment of the present invention.

As shown in FIG. 2, the pad 100 may include an additional frame 110 having an additional support surface 111. The additional frame 110 may be made of the same material as the pad 100 to support the user's spine stably and at the same time for the user not to feel foreign body sensation, but any material may be used as long as it may support the user's spine and the user may not feel foreign body sensation.

A separate support bar 110a may be provided on the lower surface of the additional frame 110. For example, the support bar 110a may be made of a metal material having sufficient rigidity, but any material capable of sufficiently withstanding the applied load may be used, and it may be made of a synthetic resin material such as carbon fiber reinforced plastic.

In this way, when the support bar 110a is configured to support the lower surface of the additional frame 110, the additional frame 110 stably supports the user's spine and the user does not feel foreign body sensation, thereby improving user satisfaction.

The support bar 110a may be connected to a main bar supporting the pad 100, thereby improving structural stability of the support bar 110a.

As shown in FIGS. 3 and 4, the massage module 200 may include a transfer part 210 that moves along the longitudinal direction X; a support part 220 wherein the acupressure member 221 is disposed on one side of the support part and the other side of the support part is hinge-fixed to the transfer part 210; and a lifting/lowering part 230 that raises or lowers one side of the support part 220.

In this case, the transfer part 210 may include a plate-shaped base plate and base ribs provided at both ends of the base plate in the width direction Y. A support roller may be provided on the base rib, and the support roller may be movably disposed along the guide rail disposed along the longitudinal direction X. A transfer motor providing a driving force so that the support roller moves along the guide rail may be provided in the transfer part 210.

The acupressure member 221 may be disposed on the upper surface of one side of the support part 220, and the other side of the support part 220 may be hinge-fixed to the transfer part 210. In other words, when one side of the support part 220 rises through the operation of the lifting/lowering part 230, the acupressure member 221 rises together, and since the other side of the support part 220 is hinge-fixed, as one side of the support part 220 rises while drawing a circular arc, the effect of pressing in the height direction Z and the effect of pushing in the longitudinal direction X can be provided in combination, thereby improving the thermal massage effect.

In this case, the support part 220 includes support members 222 disposed on one side and the other side in the width direction Y, respectively, and an acupressure tool 221a may be disposed on each support member 222.

In other words, since the support members 222 are placed on one side and the other side in the width direction, respectively, and the acupressure tool 221a is placed on the upper surface of one side of the support member 222, respectively, not only can the user be effectively pressed through the acupressure tool 221a when the support member 222 rises, but also the support members 222 are divided, preventing the support member 222 from interfering with the additional frame 110 equipped with the additional support surface 111, thereby stably supporting the user's spine.

In this case, the hollow portion (a) may be configured to have a width corresponding to the width of the support member 222 so that the acupressure tool 221a rises to a higher position or descends to a lower position than the support surface 100a while the massage module 200 moves along the longitudinal direction X.

In other words, the shape of the user's spine is different depending on the user, and the acupressure tool 221a rises or descends according to the different spine shapes, and in particular, the hollow portion (a) extending along the longitudinal direction X has a width corresponding to the width of the support member 222, allowing the acupressure tool 221a to rise or descend to a position higher or lower than the support surface 100a at any position arranged along the longitudinal direction X.

For example, the hollow portion (a) may be formed to have a constant width along the height direction Z. In this case, the width of the hollow portion (a) corresponding to the width of the support member 222 is formed equal to the width of the support member 222 so that the support member 222 can pass through the hollow portion (a) during the process of rising or descending, but it is also possible to form a predetermined length larger than the width of the support member 222 by several mm to prevent the support member 222 from contacting the inner surface of the hollow portion (a) during the process of rising or descending.

Alternatively, it is also possible to form a step difference along the height direction Z on the inner surface of the hollow portion (a). In other words, the width of the lower side of the height direction Z of the hollow portion (a) is configured to have a width enough for the support member 222 to pass, and the width of the upper side of the height direction Z of the hollow part (a) is configured to have a width enough only for the acupressure tool 221a provided on the upper surface of the support member 222 to pass. That is, only the acupressure tool 221a is configured to move to a position higher than the support surface 100a, thereby supporting the user's body more stably.

Alternatively, the hollow portion (a) may be configured to have a width corresponding to the width of the acupressure tool 221a so that the acupressure tool 221a rises to a higher position or descends to a lower position than the support surface 100a while the massage module 200 moves along the longitudinal direction X.

In other words, the shape of the user's spine is different depending on the user, and the acupressure tool 221a rises or descends according to the different spine shapes, and in particular, the hollow portion (a) extending along the longitudinal direction X has a width corresponding to the width of the acupressure tool 221a, allowing the acupressure tool 221a to rise or descend to a position higher or lower than the support surface 100a at any position arranged along the longitudinal direction X.

In this case, it is also possible to form a step difference along the height direction Z on the inner surface of the hollow portion (a). In other words, the width of the lower side of the height direction Z of the hollow portion (a) is configured to have a width enough for the support member 222 to pass, and the width of the upper side of the height direction Z of the hollow part (a) is configured to have a width enough only for the acupressure tool 221a provided on the upper surface of the support member 222 to pass. That is, only the acupressure tool 221a is configured to move to a position higher than the support surface 100a, thereby supporting the user's body more stably.

As shown in FIG. 2, the lower surface of the additional frame 110 may be disposed adjacent to the upper surface of the transfer part 210. In other words, the fact that the lower surface of the additional frame 110 is disposed adjacent to the upper surface of the transfer part 210 means that the lower surface of the additional frame 110 is configured to be disposed at a position lower along the height direction Z than the upper surface of the support member 222.

As described above, even though it is configured in this way, since the hollow portion (a) is configured to have a width corresponding to the width of the support member 222, there is no interference with the additional frame 110 when the support member 222 rises or descends, and furthermore, as the lower surface of the additional frame 110 is disposed adjacent to the upper surface of the transfer part 210, the height of the massage module 200 is lowered, making it possible to miniaturize the massage device.

As shown in FIGS. 3 and 4, the lifting/lowering part 230 may include a lifting/lowering member 231 provided on each support member 222, and a driving member 232 that provides driving force for the lifting/lowering member 231 to rise or descend along the height direction Z.

The lifting/lowering member 231 may be a rack 231a provided in each support member 222, for example, a first rack 231a1 may be provided in the support member 222 disposed on one side in the width direction Y, and a second rack 231a2 may be provided in the support member 222 disposed on the other side in the width direction Y.

In addition, the driving member 232 may be a driving motor for providing a driving force, and such a driving motor may be provided with a pinion 232a connected to a driving shaft of the driving motor. That is, when the pinion 232a rotates in one direction or the other direction according to the rotation of the driving shaft, the rack 231a rises or descends along the height direction Z. The pinion 232a may include a first pinion 232a1 disposed on one side of the driving motor and a second pinion 232a2 disposed on the other side of the driving motor.

In addition, a hinge member 233 may be provided on the other side of the support member 222 to be hinge-fixed to the transfer part 210, and this hinge member 233 may include a pin 233a. The pin 233a may include a first pin 233a1 disposed on one side in the width direction Y and a second pin 233a2 disposed on the other side in the width direction Y.

That is, as the first pinion 232a1 and the second pinion 232a2 provided in the driving member 232 rotate, the first rack 231a1 and the second rack 231a2 rise or descend, and through this, each support member 222 rises or descends, and as described above, the support member 222 is placed on both sides in the width direction Y, enabling a smooth rising or descending operation without interference with the additional frame 110.

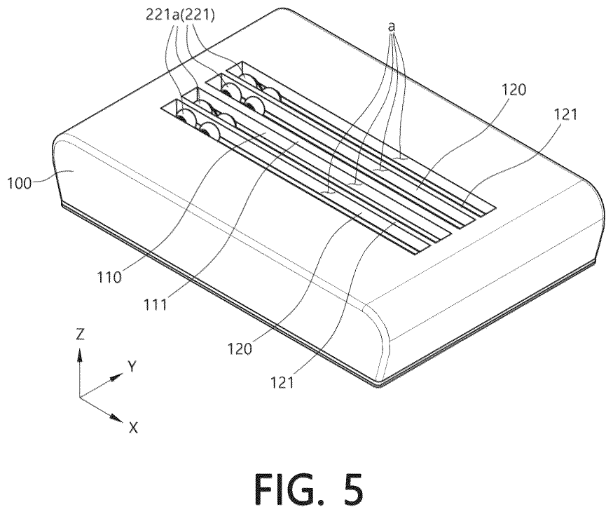

FIG. 5 is a perspective view of a massage device according to another exemplary embodiment of the present invention.

As shown in FIG. 5, the support member 222 includes a plurality of unit plates 222a divided along the width direction Y, each unit plate 222a has an acupressure tool 221a, and the pad 100 may be provided with an additional support surface 121 disposed between the unit plates 222a to support the user's body.

That is, as the acupressure tool 221a is respectively disposed on the plurality of unit plates 222a divided along the width direction Y, and the additional support surface 121 is provided between these unit plates 222a, this additional support surface 121 prevents the user's body from falling into the hollow portion (a) when the user lies on the support surface 100a of the pad 100, thereby allowing the user to lie comfortably on the pad 100 or easily raise the upper body after massage, thereby improving user convenience.

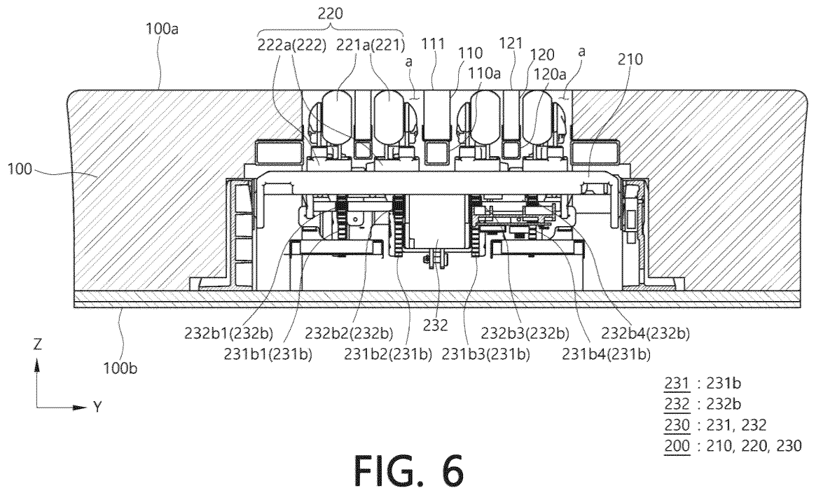

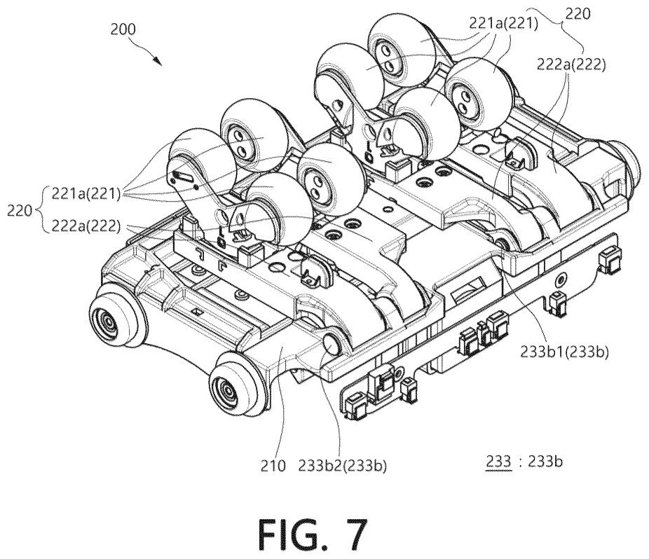

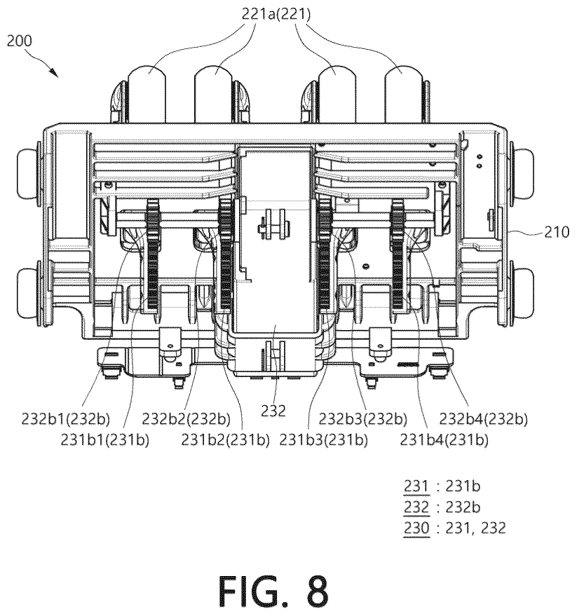

FIG. 6 is a cross-sectional view illustrating a state in which a massage module is inserted and disposed in a massage device according to another exemplary embodiment of the present invention, FIG. 7 is a perspective view of a massage module according to another exemplary embodiment of the present invention, and FIG. 8 is a front view illustrating a massage module viewed from the bottom according to another exemplary embodiment of the present invention.

As shown in FIG. 6, the pad 100 may further include a unit frame 120 having an additional support surface 121. The unit frame 120 may be made of the same material as the pad 100 to support the user's body stably and at the same time for the user not to feel foreign body sensation, but any material may be used as long as it may support the user's body and the user may not feel foreign body sensation.

A separate unit support bar 120a may be provided on the lower surface of the unit frame 120. For example, the unit support bar 120a may be made of a metal material having sufficient rigidity, but any material capable of sufficiently withstanding the applied load may be used, and it may be made of a synthetic resin material such as carbon fiber reinforced plastic.

In this way, when the unit support bar 120a is configured to support the lower surface of the unit frame 120, the unit frame 120 stably supports the user's body and the user does not feel foreign body sensation, thereby improving user satisfaction.

The unit support bar 120a may be connected to a main bar supporting the pad 100, thereby improving structural stability of the unit support bar 120a.

As shown in FIGS. 7 and 8, the lifting/lowering part 230 may include a lifting/lowering member 231 provided on each unit plate 222a, and a driving member 232 that provides driving force for the lifting/lowering member 231 to rise or descend along the height direction Z.

The lifting/lowering member 231 may be a unit rack 231b provided in each unit plate 222a, and for example, each unit rack 231b may be a first-1 unit rack 231b1, a first-2 unit rack 231b2, a second-1 unit rack 231b3, and a second-2 unit rack 231b4 sequentially along the width direction Y.

In addition, the driving member 232 may be a driving motor for providing a driving force, and such a driving motor may be provided with a unit pinion 232b connected to a driving shaft of the driving motor. That is, when the unit pinion 232b rotates in one direction or the other direction according to the rotation of the driving shaft, the unit rack 231b rises or descends along the height direction Z. The unit pinion 232b may include a first-1 unit pinion 232b1 and a first-2 unit pinion 232b2 disposed on one side of the driving motor, and a second-1 unit pinion 232b3 and a second-2 unit pinion 232b4 disposed on the other side of the driving motor. In this case, the first-1 unit pinion 232b1 and the first-2 unit pinion 232b2 may be disposed on a single rotation axis extending along the driving shaft, and the second-1 unit pinion 232b3 and the second-2 unit pinion 232b4 may also be disposed on a single rotation axis extending along the driving shaft.

In addition, a hinge member 233 may be provided on the other side of the unit plate 222a to be hinge-fixed to the transfer part 210, and this hinge member 233 may include a unit pin 233b. The unit pin 233b may include a first unit pin 233b1 disposed on one side in the width direction Y and a second unit pin 233b2 disposed on the other side in the width direction Y. That is, all the divided unit plates 222a disposed on one side in the width direction Y are hinge-fixed through the first unit pin 233b1, and all the divided unit plates 222a disposed on the other side in the width direction are hinge-fixed through the second unit pin 233b2. Alternatively, the present invention is not necessarily limited thereto, and it is also possible to include a unit pin 233b so that each unit plate 222a is hinge-fixed.

That is, as the first-1 unit pinion 232b1, the first-2 unit pinion 232b2, the second-1 unit pinion 232b3, and the second-2 unit pinion 232b4 provided in the driving member 232 rotate,
the first-1 unit rack 231b1, the first-2 unit rack 231b2, the second-1 unit rack 231b3, and the second-2 unit rack 231b4 rise or descend, and through this, each unit plate 222a rises or descends, and as described above, each unit plate 222a is divided and disposed, so that smooth rising or descending operations are possible without interference with the unit frame 120.

As discussed above, in the massage device having a massage module according to an exemplary embodiment of the present invention, the additional support surface 111 for supporting the user's body is provided between the acupressure tools 221a arranged opposite to each other in the state in which the acupressure tools 221a arranged on both sides of the width direction Y rise to a higher position or descend to a lower position than the support surface 100a of the pad 100, thereby minimizing the user's body falling into the hollow portion (a), thereby improving user convenience by allowing the user to lie comfortably on the pad 100 or easily raise the upper body after massage.

Although exemplary embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the scope of the present invention.

1. A massage device having a massage module, the massage device comprising:
a pad having a support surface for supporting a body of a user, and an opposite surface disposed to be opposite to the support surface; and
a massage module insertively disposed in the pad and having acupressure members that press the body of the user while moving in the longitudinal direction,
wherein the acupressure members comprise acupressure tools each arranged at one side and the other side of the acupressure member in the width direction with respect to the center of the acupressure member in the width direction,
wherein the support surface has hollow portions through which the acupressure tools are able to move so that the acupressure tools are raised to a higher position than that of the support surface in the height direction while the massage module is moving, and
wherein the pad has an additional support surface disposed between the acupressure tools arranged to be opposite to each other to support the user's body.

2. The massage device having a massage module of claim 1, wherein the pad comprises an additional frame having the additional support surface.

3. The massage device having a massage module of claim 2, wherein the massage module comprises a transfer part that moves along the longitudinal direction, a support part wherein the acupressure member is disposed on one side of the support part and the other side of the support part is hinge-fixed to the transfer part, and a lifting/lowering part that raises or lowers one side of the support part.

4. The massage device having a massage module of claim 3,
wherein the support part comprises support members disposed on one side and the other side of the support part in the width direction, respectively, and
wherein the acupressure tool is disposed on each said support member.

5. The massage device having a massage module of claim 4, wherein the hollow portion has a width corresponding to a width of the support member so that the acupressure tool rises to a higher position or descends to a lower position than the support surface while the massage module moves along the longitudinal direction.

6. The massage device having a massage module of claim 4, wherein the hollow portion has a width corresponding to a width of the acupressure tool so that the acupressure tool rises to a higher position or descends to a lower position than the support surface while the massage module moves along the longitudinal direction.

7. The massage device having a massage module of claim 4, wherein a lower surface of the additional frame is disposed adjacent to an upper surface of the transfer part.

8. The massage device having a massage module of claim 4, wherein the lifting/lowering part comprises a lifting/lowering member provided on each said support member, and a driving member that provides driving force for the lifting/lowering member to rise or descend along the height direction.

9. The massage device having a massage module of claim 4,
wherein the support member comprises a plurality of unit plates divided along the width direction,
wherein each said unit plate has the acupressure tool, and
wherein the pad has an additional support surface disposed between the unit plates to support the user's body.

10. The massage device having a massage module of claim 9, wherein the pad further comprises a unit frame having the additional support surface.

11. The massage device having a massage module of claim 10, wherein the lifting/lowering part comprises a lifting/lowering member provided on each said unit plate, and a driving member that provides driving force for the lifting/lowering member to rise or descend along the height direction.
